(19) United States
(12) Patent Application Publication
(10) Pub. No.: US 2022/0222342 A1
(43) Pub. Date: Jul. 14, 2022

(54) MONITORING METHOD OF STATIC OBJECT TAMPERING IN HYBRID ENVIRONMENT

(71) Applicant: Yong MA, Nanchang City (CN)

(72) Inventor: Yong MA, Nanchang City (CN)

(21) Appl. No.: 16/311,640

(22) Filed: Dec. 19, 2018

(30) Foreign Application Priority Data
Nov. 20, 2018 (CN) 201811380686.6

(51) Int. Cl. G06F 21/56; G06F 21/64

(52) U.S. Cl. CPC G06F 21/565; G06F 21/64

(57) ABSTRACT

A monitoring method of static object tampering in hybrid environment includes the steps of monitoring whether or not a static object is tampered with or monitoring all static objects item by item to detect if any of them is tampered with, recording the number of tampering, determining whether or not the number of tampering has reached a predetermined number of times t1, monitoring whether or not a middleware is tampered with when the predetermined number of times t1 is reached; and monitoring whether or not the operating system is tampered with. This method not just provides a quick way of monitoring static object tampering only, but also explores the cause why the static object is tampered with, and carries out parallel or serial operations of the monitoring steps flexibly and efficiently.

### FIELD OF THE INVENTION

The present invention relates to the field of computer security, and more particularly to a monitoring method of static object tampering in hybrid environment.

### BACKGROUND OF THE INVENTION

As the Internet becomes increasingly popular in our daily life, we get lots of information from website resources, particularly by visiting official websites of the government and major portals. The information published on these websites contains policies and current affairs, and thus these websites become the main target for hacking attacks, especially in network attacks. Once a webpage has been tampered with by hackers, it often leads to adverse social impacts, especially the tampering with political attack which usually seriously damages the image of the government. Web servers such as Apache, IIS, etc. are lack of a comprehensive protection mechanism for a user requested page, and their webpage cannot be prevented from being tampered with. In recent years, the information infrastructure of large enterprises has undergone tremendous changes, especially the key technologies of Internet+(cloud computing, Internet of Things, big data, and mobile computing) have profound impacts on information infrastructure deployment architecture. These infrastructures mainly face new challenges brought by static object protection technologies in the trend for concentration, mobility sharing, etc.

The static object protection technology has gone through technical upgrades and repeated computations. The first-generation anti-tampering technology is a time polling technology as known as external polling technology with the main idea of using a webpage monitoring program to read target monitoring webpages by polling and webpages browsed by users and determine the integrity of the contents of a webpage by comparing the aforementioned two kinds of webpages in order to recover and alert a tampered page. The second-generation anti-tampering technology is a time-triggered & core embedded technology with the main idea of storing a webpage file with asymmetric encryption, and decrypting and releasing the encrypted and visited file upon the receipt of external access requests, wherein if the verification is not passed, the release to the public will be refused, and the backup file will be verified and decrypted, and then released instead. The third-generation anti-tampering technology is a combination of file filter driver & event trigger technologies with the main idea of applying the core tampering monitoring program to a web server through a low level driver technology, performing the automatic monitoring through an event trigger to compare the attributes of all low-level files in the target file, and adopting a built-in fast hash algorithm to compute a digital fingerprint for instant monitoring. If the attribute is changed, the content of the backup path data will be copied to the corresponding location of the monitored file folder by a non-protocol plain-text security copy method. The low-level file driver technology is used to make the entire file copying process to a millisecond level and the public unable to see the tampered page.

After repeated improvements of the aforementioned tampering monitoring technologies, the current static object anti-tampering monitoring method is well developed, but all of the aforementioned three generations of anti-tampering technologies have the following issue: The current anti-tampering monitoring method can just monitor the static objects in a webpage only, and only the tampered static file can be monitored and repaired. Such method is reactive rather than proactive and it merely treats the symptoms but not the disease. The cause of tampering of the static object cannot be discovered from a deep level, and thus effective responses cannot be taken for the tampering. For example, if the current monitoring technology finds that a certain webpage has been tampered with, the tampered file will be repaired and related viruses will be found. If the system middleware is tampered with or the fixed webpage is tampered with again, then the static file will be tampered repeatedly, and such repair has no effect, and the frequency of tampering cannot be counted.

In view of the aforementioned drawbacks of the prior art, the inventor of the present invention based on years of experience to conduct extensive research and experiment, and finally provided a feasible solution to overcome the drawbacks of the prior art.

### SUMMARY OF THE INVENTION

Therefore, it is a primary objective of the present invention to overcome the aforementioned drawbacks of the prior art by providing a monitoring method of static object tampering in hybrid environment and the method is capable of monitoring whether or not a static object is tampered with and finding the profound cause of tampering. After a static file is monitored and determined to be tampered with, the statistics of the situation is counted. The method further monitors whether or not a middleware and an operating system are tampered with, so as to find the cause of tampering and prepare for sequent repairs.

To achieve the aforementioned and other objectives, the present invention provides a monitoring method of static object tampering in hybrid environment, comprising the following steps:

S1: Monitor whether or not a static object is tampered with. Specifically, the static objects are monitored sequentially to detect whether or not any static object is tampered with. Record the number of tampering. Determine whether or not the number of tampering exceeds the predetermined number t1, and if yes, carry out the Step S2.

S2: Monitor whether or not a middleware is tampered with.

S3: Monitor whether or not an operating system is tampered with.

In a preferred embodiment, the step of determining whether or not the number of tampering reaches a predetermined number t1 further determines whether or not the cumulative number of tampering of any one static object reaches the predetermined number t1 during the process of monitoring each static object sequentially.

In a preferred embodiment, the Steps S2 and S3 are executed synchronously, and these steps further comprise the following steps:

S51: Determine the number of tampering of any one middleware and any one system file reaches the predetermined number t1; and if no, carry out the Step S52 and/or the Step S53.

S52: Determine whether or not the number of tampering of any one middleware ≥t2.

S53: Determine whether or not the number of tampering of any one operating system file ≥t2.

S54: Feedback a tampered result.

In a preferred embodiment, the step of determining whether or not the number of tampering reaches the predetermined number of times t1 further comprises the step of determining the cumulative number of tampering of all static objects reaches a predetermined number of times T1.

In a preferred embodiment, the Steps S2 and S3 are executed synchronously, and these steps further comprise the following steps:

S61: Determine whether or not the cumulative number of tampering of the middleware and the tampering number of the system file reach the predetermined number of times T1, if no, carry out the Step S62 and/or the Step S63.

S62: Determine whether or not the cumulative number of tampering of the middleware ≥t.

S63: Determine whether or not the cumulative number of tampering of the system file ≥t.

S64: Feedback a tampered result.

In a preferred embodiment, the Steps S62 and S63 are parallel steps, and the sequence of executing these steps is not limited.

In a preferred embodiment, the method of the present invention further comprises the following step:

S4: Monitor whether or not a seed file is tampered with.

In a preferred embodiment, the Step S4 further comprises the following steps:

S41: Determine whether or not a static object seed file, a middleware seed file, and an operating system seed file are tampered with. If no, each seed file of the static object, each seed file of the middleware, and each seed file of the operating system are monitored one by one. Record the number of tampering of various types of the seed files.

In a preferred embodiment, the step of monitoring each seed file of the static object, each seed file of the middleware, and each seed file of the operating system one by one and then recording the number of tampering of various types of the seed files further comprises the following steps:

S42: Determine whether or not the static object seed file and the middleware seed file are tampered with. If no, then Step S45 will be executed.

S43: Determine whether or not the static object seed file and the operating system seed file are tampered with. If no, then the Step S45 will be executed.

S44: Determine whether or not the middleware seed file and operating system seed file are tampered with. If no, then the Step S45 will be executed.

S45: Determine whether or not the static object seed file is tampered with. If no, then S46 will be executed.

S46: Determine whether or not the middleware seed file is tampered with. If no, then S47 will be executed.

S47: Determine whether or not the operating system seed file is tampered with. If no, then the monitoring process will be ended.

In a preferred embodiment, the Step 4 for monitoring whether or not the seed file is tampered with, only if the middleware is monitored and determined to be tampered with and/or the operating system file is monitored and determined to be tampered with.

With the implementation of this method, all static objects are detected objects, and statistics with regard to the tampering situation of the static objects are counted. After any static object is found to be tampered with, the middleware, operating system and seed file are inspected, and a flexible monitoring program is provided according to the requirements of different levels of security. By the inspection of the static object, middleware and system file layer by layer, the monitoring method is effective and efficient. Users can find out the cause of the tampering of the static object and can prepare for the next step of their work well.

### BRIEF DESCRIPTION OF THE DRAWINGS

FIG. 1 is a flow chart of a monitoring method of static object tampering in hybrid environment in accordance with an embodiment of the present invention;

FIG. 2 is a flow chart of a Step (S2) of a monitoring method of static object tampering in hybrid environment in accordance with an embodiment of the present invention;

FIG. 3 is a flow chart of a Step (S3) of a monitoring method of static object tampering in hybrid environment in accordance with an embodiment of the present invention;

FIG. 4 is a flow chart of a Step (S4) of a monitoring method of static object tampering in hybrid environment in accordance with an embodiment of the present invention;

FIG. 5 is a flow chart of a Step (S5) of a monitoring method of static object tampering in hybrid environment in accordance with an embodiment of the present invention; and

FIG. 6 is a flow chart of a monitoring method of static object tampering in hybrid environment in accordance with another embodiment of the present invention.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

The details of some of the related terminology used in the present invention are given below:

Hybrid Environment: This environment is mainly based on the cloud computing environment and traditional IT structured physical computing environment which exist concurrently in IT infrastructure of data centers.

Static Object: It refers to a non-changing electronic file stored in a computer in form of text files, design drawings, videos, images, etc.

Seed File: For storage in a cloud computing environment, all local data usage and system are retrieved from a cloud platform, and the content of the static object, middleware and operating system stored in the cloud platform is defined as a seed file.

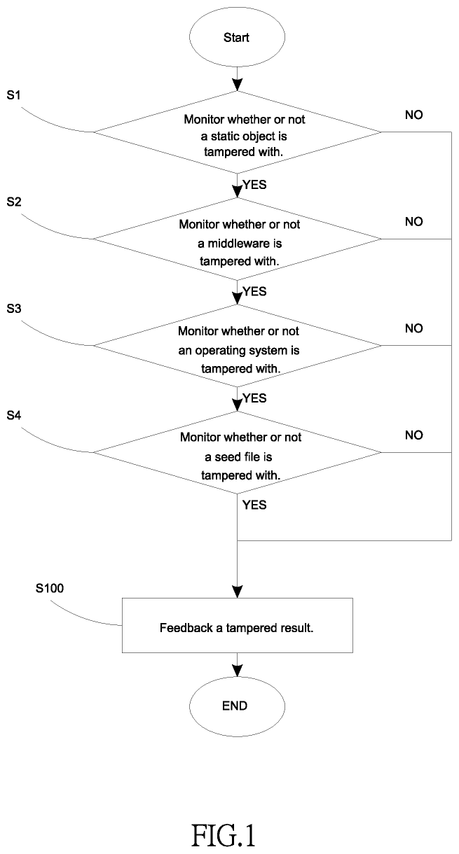

With reference to FIG. 1 for a monitoring method of static object tampering in hybrid environment in accordance with the present invention, the monitoring method of static object tampering in hybrid environment comprises the following steps:

S1: Monitor whether or not a static object is tampered with. If yes, then Step S2 will be executed. In this step, a monitoring program is provided for instantly monitoring whether or not a static object is tampered with. If the monitoring program finds that the static object is tampered with, then the Step S2 will be executed. Specifically, the monitoring software may adopt a hash computing verification method to determine one by one whether or not any static object is tampered with and record the number of tampering and the tampered static object.

S2: Monitor whether or not a middleware is tampered with. If yes, then Step S3 will be executed. After the monitoring program finds that a static object is tampered with, the cause of tampering will be determined whether the static object is tampered with by an illegal program or the middleware is tampered with to lead to the result of the static object being tampered with. Therefore, after the Step S1 is executed and the monitoring program finds that the static object is tampered, the middleware is further monitored to determine whether or not the middleware is tampered with.

S3: Monitor whether or not an operating system is tampered with. If yes, then Step S4 will be executed. Particularly, if the middleware of a storage system is monitored and determined to be tampered with (as described in the Step S2), then it will be necessary for this monitoring method to further monitor whether or not the operating system is tampered with in order to determine the cause of tampering.

S4: Monitor whether or not a seed file is tampered with. For the cloud platform storage in hybrid environment, local static objects, middleware and/or an operating system may be tampered with due to the reason that their corresponding sources have been tampered with. For systems in a hybrid environment of local blurred cloud computing, the seed file is further monitored to find out the root cause of the tampering and provide a basis for the next step of repair.

S100: Record a tampered result. After the foregoing steps are completed, all tampered results are recorded and fed back to provide reference for the next step of processing.

In other embodiments, the Steps S2, S3 and S4 do not take place progressively, but concurrently.

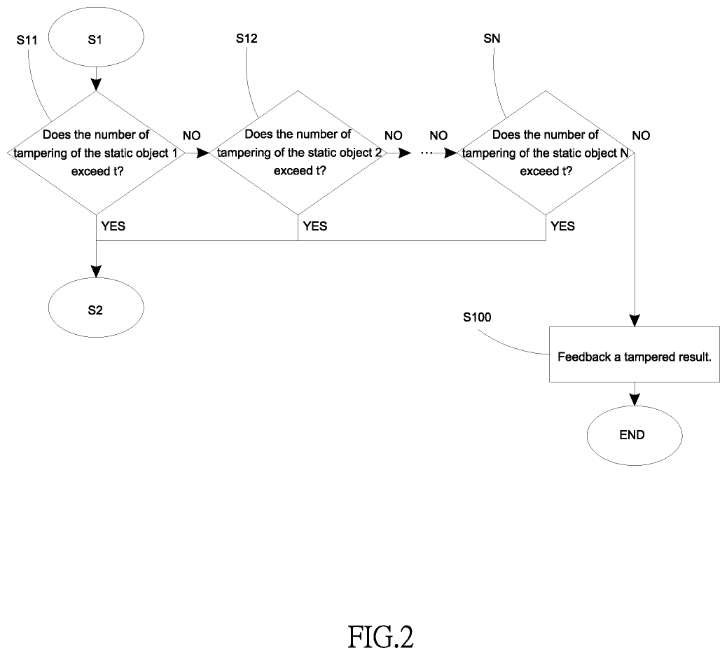

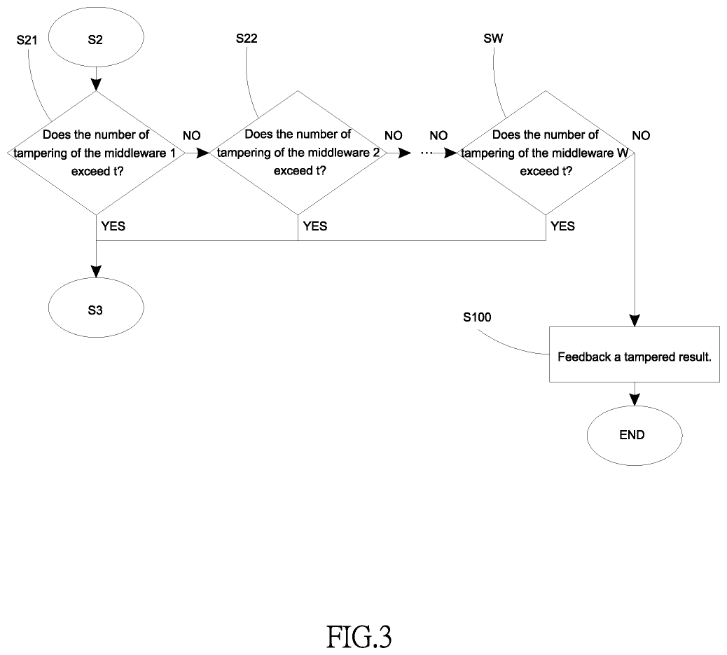

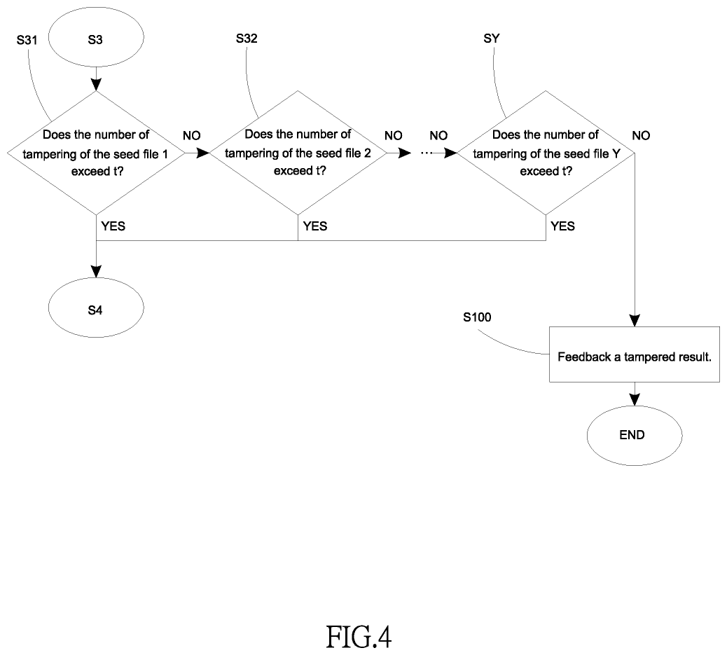

In FIGS. 2 to 4, the static object is monitored as described in the Step S1. There are several static objects in a server, so that the static objects are monitored one by one. Wherein, the quantity of static objects is N, and these static objects are named as static object 1, static object 2 . . . static object N−1, static object N sequentially.

S11: Determine whether or not the number of tampering of the static object 1 reaches a predetermined number t1. If yes, then Step S2 will be executed, or else Step S12 will be executed. In a monitoring process, the value of t1 may be defined according to the security level of the using environment. For example, the value of t1 is set to be 1 for a server of a government unit that requires a high security level. In other words, the Step S2 is required, as long as the static object 1 is found to be tampered with. For the environment requiring a general security level, the value of t1 may be set to be 2. In other words, if the static object 1 has been tampered twice, then the Step S2 will be executed, or else the Step S12 will be executed.

S12: Determine whether or not the number of tampering of the static object 2 reaches the predetermined number t1. If yes, the Step S2 then will be executed, or else the Step S13 will be executed. In summation, if the monitoring shows that the number of tampering of a certain static object ≥t1, then the Step S2 then will be executed, or else Steps S13, S14, S15 . . . . S1N will be executed. If the number of tampering of a certain static object is still not ≥t1 after the Step S1N takes place, then Step S100 will be executed.

In another embodiment, the static objects 1˜N are monitored sequentially in the monitoring process, and the monitoring method determines whether or not the cumulative number of tampering of all static objects reaches a predetermined number T1. If yes, then Step S2 will be executed, or else the monitoring process will be ended. In a specific determination process, for example, if the number of tampering of the static object 1 is equal to 1, and both numbers of tampering of the static object 2 and the static object 3 are equal to 0, and the number of tampering of the static object 4 is equal to 2, then the cumulative number of tampering will be equal to 3.

In the Step S2 of monitoring the middleware, there are several middleware which will be monitored one by one in the monitoring process. If the quantity of middleware is equal to W, and these middleware are middleware 1, middleware 2, . . . middleware W respectively. In Step S2, Steps S21, S22, . . . S2W are executed.

Further, a hash verification method is provided for monitoring whether or not each middleware is tampered with.

S21: Determine whether or not the number of tampering of the middleware 1 reaches a predetermined number t2. If yes, then Step S3 will be executed, or else Step S22 will be executed. In an actual monitoring process, the value of t2 may be set according to the security level of the using environment. For example, the value of t2 is set to be 1 for a server of a government unit that requires a high security level. In other words, the Step S3 is required, as long as the middleware 1 is found to be tampered with. For the environment requiring a general security level, the value of t2 may be set to be 2. In other words, if the middleware 1 has been tampered twice, then the Step S3 will be executed, or else the Step S22 will be executed.

S22: Determine whether or not the tampering of the middleware 2≥t2. If yes, then Step S3 will be executed, or else Steps S23 will be executed, wherein the Step S23 is executed in the same way as the Step S22 and sequentially up to S2W. If the number of tampering of the static objects still does not exceed t2 after the Step S2W takes place during the process of executing the steps S21 to S2W, then Step S23 will be executed. If the number of tampering of any one of the static objects exceeds t2 during the process of executing the steps S21 to S2W, then Step S3 will be executed.

In another embodiment, the middleware 1 to middleware W are monitored sequentially in the monitoring process to determine whether or not the cumulative number of tampering W middleware ≥T2. If yes, then Step S3 will be executed, or else the monitoring process will be ended. In the monitoring process as described in the Step S2, some rules are the same as those of the Step S1.

Step S3: In the monitoring process of the operating system, system files of the operating system are monitored one by one to determine whether or not any system file is tampered with. Further, the system files of the operating system are monitored by a hash verification method with the same monitoring logic as the Steps S1 and S2. On the other hand, the tampering of the operating system has a large influence on the operation of the static objects and the entire system, so that the Step S4 is required as long as the operating system is tampered with.

In other embodiments, since the static objects are monitored periodically. For example, the static objects are monitored once an hour, and the monitoring cycle is one minute. If it is found that several static objects are tampered with in a monitoring cycle, or any one static object is tampered with for several times, then the tampering will be considered to be serious. For serious tampering, the step of monitoring the middleware is skipped, and the system file will be monitored directly to detect whether or not the system file is tampered with, or the seed files will be monitored directly. In summation, after the Step S1 takes place, the sequence of executing the Steps S2, S3, and S4 is not limited to the aforementioned arrangement only, but and different conditions may be set for the monitoring sequence of the monitoring process.

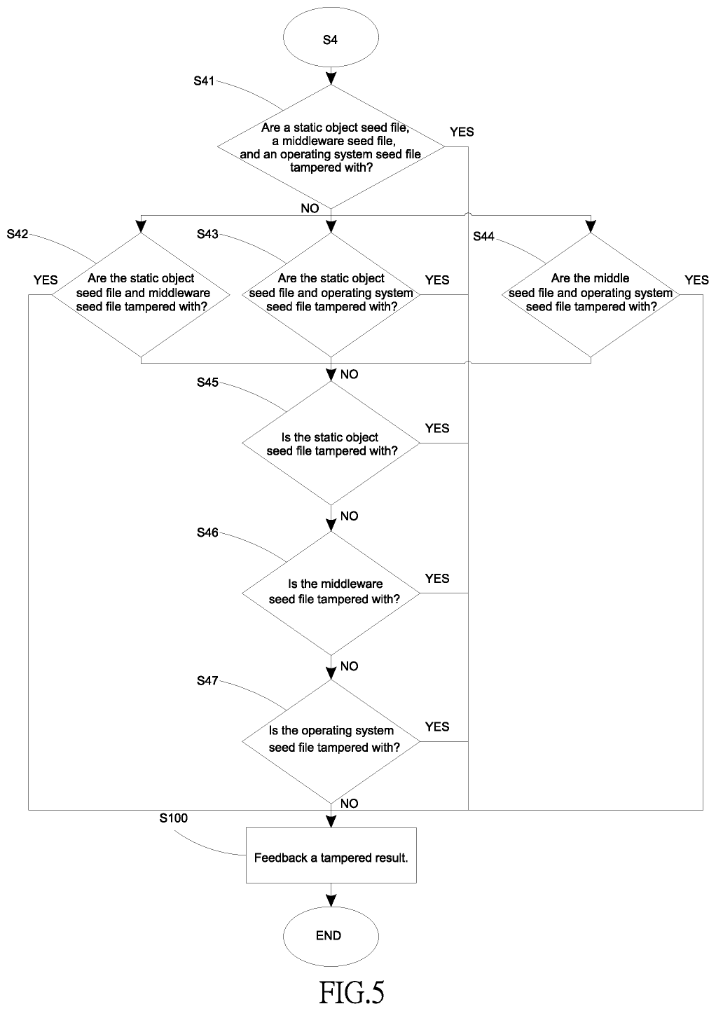

In FIG. 5, the process of executing the Step S4 is described in details below:

S41: Monitor whether or not the static object seed file, middleware seed file, and operating system seed file are tampered with. If yes, then Step S100 will be executed, or else Steps S42, S43 and S44 will be executed, wherein the Steps S42, S43, and S44 are in a parallel execution relation. In a preferred embodiment as described in the Step S41, after the seed files of the static object are monitored sequentially, and the seed files of the middleware are monitored sequentially, and the seed files of the operating system are monitored sequentially, the number of tampering is record and these seed files are determined whether or not they are tampered with. The aforementioned method comprises the following steps:

S42: Determine whether or not the static object seed file and the middleware seed file are tampered with. If yes, then Step S100 will be executed, or else Step S45 will be executed.

S43: Determine whether or not the static object seed file and the operating system seed file are tampered with. If yes, then Step S100 will be executed, or else Step S45 will be executed.

S44: Determine whether or not the middleware seed file and the operating system seed file are tampered with. If yes, then Step S100 will be executed, or else Step S45 will be executed.

S45: Determine whether or not the static object seed file is tampered with. If yes, then Step S100 will be executed, or else Step S46 will be executed.

S46: Determine whether or not the middleware seed file is tampered with. If yes, then the Step S100 will be executed, or else Step S47 will be executed.

S47: Determine whether or not the operating system seed file is tampered with. Step S100 is executed after the Step S47 takes place.

It is noteworthy that the steps S42, S43 and S44 are parallel steps that may be executed concurrently, so that the step S45, S46 and S47 may be parallel steps as well. In other words, after the steps S45, S46, and S47 are executed separately or concurrently, the procedure of the monitoring method ends. On the other end, if there is a sequence of execution, the steps S45, S46, and S47 may be switched flexibly. The present invention aims at the anti-tampering technology for the cloud computing hybrid environment to provide a seed file detection of the local files and explore the profound cause of tampering of the static object.

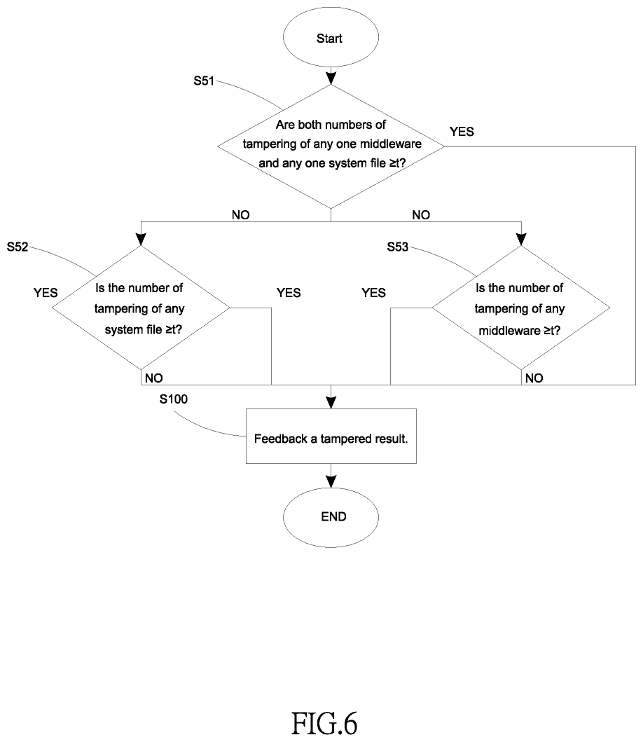

In other embodiments, the middleware and the operating system may be monitored synchronously according to the system security level whenever for a serious tampering situation of the static object is found. The steps as shown in FIG. 6 are elaborated as follows.

S51: Determine whether or not the number of tampering of any one middleware and the number of tampering of any one system file reach a predetermined number t3. If yes, then the monitoring process will be end, or else the steps S52 and S53 will be executed concurrently. In the execution of this step, the middleware and the system file are monitored sequentially.

S52: Determine whether or not the number of tampering of any one middleware ≥t3.

S53: Determine whether or not the number of tampering of any one system file ≥t3.

S54: Feedback a tampered result.

The aforementioned Step S51 has actually completed the process of monitoring the middleware and the system file according to the Steps S2 and S3 sequentially, and the Steps S52 and S53 just determine the final number of tampering and the value of t3 only. Actually, the Steps S51 and S52, and the Step S53 may be considered as sub-steps of the Steps S2 and S3 respectively.

In another embodiment, the Step S51 determines whether or not the cumulative number of tampering of the middleware and the number of tampering of the system file ≥T3, and the S52 determines whether or not the cumulative number of tampering of the system file ≥T3, S53, and determines whether or not the cumulative number of tampering of the middleware ≥T3.

In the process of monitoring the static objects according to the aforementioned embodiments of the present invention, the profound cause of tampering of the static object can be explored. The method of the present invention provides a good preparation for the repair after the monitoring process. In addition, the static objects are redefined, and they are non-changing electronic files such as text files, design drawings, video, and images stored in a computer. Understandably, these electronic files can be changed by manual operations only. The present invention has a good coverage on the loopholes of a detected object leading to an incomplete detection for webpage detection and virus detection. In addition, the method of the present invention separates the detection of the static object and middleware from the detection of the operating system and seed file to improve the monitoring effectiveness and efficiency effectively, and determines whether or not to execute the detection of other objects depending on the analyzed tampering condition of the detected static objects.

While the present invention has been described by means of specific embodiments, numerous modifications and variations could be made thereto by those skilled in the art without departing from the scope and spirit of the present invention set forth in the claims.

What is claimed is:

1. A monitoring method of static object tampering in hybrid environment, comprising the steps of:
(S1) monitoring whether or not a static object is tampered with, or monitoring all static objects item by item to detect if any of the static object is tampered with, and recording the number of tampering, and determining whether or not the number of tampering has reached a predetermined number of times t1, and executing Step (S2) if the predetermined number of times t1 is reached; and
(S2) monitoring whether or not a middleware is tampered with;

2. The method of claim 1, further comprising the step of:
(S3) monitoring whether or not an operating system file is tampered with.

3. The method of claim 1, wherein the step of determining whether or not the number of tampering has reached the predetermined number of times t1 further determines whether or not the number of tampering of any one static object ≥t1 during the process of monitoring the static objects item by item.

4. The method of claim 3, wherein the Steps (S2) and (S3) are executed synchronously, and the method of claim 3 further comprises the steps of:
(S51) determining whether or not the number of tampering of any one middleware and any one operating system file ≥t2, if no, then executing the Step (S52) and/or the Step (S53);
(S52) determining whether or not the number of tampering of any one middleware ≥t2;
(S53) determining whether or not the number of tampering of any one operating system file ≥t2; and
(S54) feeding back a tampered result.

5. The method of claim 1, wherein the step of determining whether or not the number of tampering has reached the predetermined number of times t1 further comprises the step of determining whether or not the cumulative number of tampering of all of the static objects has reached a predetermined number of times T1.

6. The method of claim 5, wherein the Steps (S2) and (S3) are executed synchronously, and the method of claim 5 further comprises the steps of:
(S61) determining whether or not the cumulative number of tampering of the middleware and the number of tampering of the system file have reached the predetermined number of times T1, if no, then executing the Step (S62) and/or the Step (S63);
(S62) determining whether or not the cumulative number of tampering of the middleware ≥t;
(S63) determining whether or not the cumulative number of tampering of the system file ≥t; and
(S64) feeding back a tampered result.

7. The method of claim 6, further comprising the step of: (S4) monitoring whether or not a seed file is tampered with.

8. The method of claim 7, wherein the Step S4 further comprises the step of: (S41) determining whether or not a static object seed file, a middleware seed file, and an operating system seed file are tampered with, and monitoring each seed file of the static object item by item, each seed file of the middleware item by item, and each seed file of the operating system, if no static object seed file, monitoring each middleware seed file, and operating system seed file are tampered with, and then recording the number of tampering of each of the various types of seed files after the monitoring process.

9. The method of claim 8, wherein each seed file of the static object is monitored item by item, each seed file of the middleware is monitored item by item, and each seed file of the operating system is monitored item by item, and then the number of tampering of various type of seed files is recorded after the monitoring process, and the method further comprises the steps of:
(S42) determining whether or not the static object seed file and the middleware seed file are tampered with, and executing the Step (S45) if none of the static object seed file and the middleware seed file are tampered with;
(S43) determining whether or not the static object seed file and the operating system seed file are tampered with, and executing the Step (S45) if none of the static object seed file and operating system seed file are tampered with;
(S44) determining whether or not the middleware seed file and the operating system seed file are tampered with, and executing the (S45) if none of the middleware seed file and the operating system seed file are tampered with;
(S45) determining whether or not the static object seed file is tampered with, and executing the Step (S46) if no static object seed file is tampered with;
(S46) determining whether or not the middleware seed file is tampered with, and executing the Step (S47) if no middleware seed file is tampered with;
(S47) determining whether or not the operating system seed file is tampered with; and
(S48) recording the number of tampering of various types of seed files.

10. The method of claim 7, wherein if the middleware is detected to be tampered with and/or the operating system file is detected to be tampered with, then the Step (S4) for monitoring whether or not the seed files are tampered will be executed.
